(19) United States
(12) Patent Application Publication
(10) Pub. No.: US 2009/0085463 A1
(43) Pub. Date: Apr. 2, 2009

(54) THERMO-OPTICALLY FUNCTIONAL COMPOSITIONS, SYSTEMS AND METHODS OF MAKING

(75) Inventors: David Jeffrey Bryan, Matthews, NC (US); Vikas Midha, Clifton Park, NY (US); William Paul Minnear, Clifton Park, NY (US); Gregory Michael Gratson, Ballston Lake, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/864,295

(22) Filed: Sep. 28, 2007

(51) Int. Cl. H01J 1/62; F21H 1/00; F21H 1/02; F21H 3/00

(52) U.S. Cl. 313/503; 252/492; 427/159; 428/336

(57) ABSTRACT

A high temperature, stabilized thermo-optically functional composite is disclosed. The composite includes a phase stabilized matrix including a first component stabilized by a second component and a plurality of discrete metallic particles interspersed with respect to the matrix, wherein the composite is stable at temperatures greater than about 2000 degrees K.

### BACKGROUND

The presently claimed invention relates generally to thermo-optically functional materials and related methods and systems.

The incandescent lamp is extensively used as an affordable light source. A conventional incandescent lamp includes a tungsten filament that radiates when heated to high temperature. One of the big advantages of the tungsten filament is that it selectively emits light in the visible spectrum. However, even with this selective emission, a filament operating at 2600K only emits about 9% of the total radiation in the visible spectrum. The vast majority of the energy is emitted in the infrared (IR) spectrum and lost as heat. The efficiency and efficacy of the incandescent light bulb could be greatly improved by reducing the IR energy loss.

Photonic lattices are typically composed of two materials having greatly differing dielectric constants arranged into periodic structures. These periodic photonic lattices have the unique property that radiation of specific wavelengths cannot propagate through the lattice. Enhanced efficiency in visible wavelengths can result if the photonic lattice material is configured to suppress IR emissions. Unfortunately, many of the photonic lattices are limited to low temperature, less than 1000 degrees K, operation due to thermal instabilities.

Therefore, it would be advantageous to develop high temperature, stabilized materials with tailored thermal optical properties.

### Brief Description

In accordance with one aspect of the disclosure, a high temperature, stabilized thermo-optically functional composite is disclosed. The composite includes a phase stabilized matrix including a first component stabilized by a second component and a plurality of discrete metallic particles interspersed with respect to the matrix, wherein the composite is stable at temperatures greater than about 2000 degrees K.

In accordance with another aspect of the disclosure, a radiation emitter is described. The radiation emitter includes a luminous element configured to emit thermal radiation in the visible region of the electromagnetic spectrum, wherein the luminous element includes a high temperature, stablilized, thermo-optically functional composite including discrete metallic particles interspersed within a phase stabilized matrix including a first component stabilized by a second component, wherein the composite is stable at temperatures greater than about 2000 degrees K.

In accordance with a further aspect of the disclosure, a radiation source is disclosed. A radiation source includes a base, a light-transmissive envelope coupled to the base, high temperature, stablilized, thermo-optically functional composite disposed within the light-transmissive envelope, the high temperature, stablilized, thermo-optically functional composite including discrete metallic particles interspersed within a phase stabilized matrix including a first component stabilized by a second component, wherein the composite is stable at temperatures greater than about 2000 degrees K and emits visible radiation upon thermal excitation.

In accordance with a further aspect of the disclosure, a method of making a stabilized thermo-optically functional composite. The method includes forming a composition of a first component, a second component and a plurality of metallic particles, wherein the second component is capable of stabilizing the first component.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic view of a composite in accordance with one embodiment of the present invention;

FIG. 2 illustrates schematic view of a composite in accordance with another embodiment of the present invention;

FIG. 3 illustrates a schematic view of a composite in accordance with another embodiment of the present invention;

FIG. 4 illustrates a method of making a composite in accordance with one embodiment of the present invention;

FIG. 5 illustrates a method of making a composite in accordance with another embodiment of the present invention;

FIG. 6 illustrates a method of making a composite in accordance with another embodiment of the present invention;

FIGS. 7-11 illustrate examples of emitter filaments in accordance with embodiments of the present invention;

FIG. 12 illustrates an incandescent lamp including an emitter in accordance with one embodiment of the present invention;

FIG. 13 illustrates an incandescent lamp including an emitter in accordance with another embodiment of the present invention;

FIG. 14 illustrates an incandescent lamp including an emitter in accordance with another embodiment of the present invention;

FIG. 15 is a scanning electron microscope (SEM) micrograph of a composite in one embodiment of the present invention;

FIG. 16 is an SEM micrograph of a composite in one embodiment of the present invention;

FIG. 17 is an SEM micrograph of a composite in one embodiment of the present invention;

FIG. 18 is an SEM micrograph of a composite in one embodiment of the present invention;

### DETAILED DESCRIPTION

In accordance with one or more embodiments of the presently claimed invention, composites, radiation emitters, radiation sources, and associated methods will be described herein. In the following description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed so as to imply that these operations need be performed in the order they are presented, or that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be synonymous and interpreted as open ended unless otherwise indicated.

In accordance with one aspect of the disclosure, a high temperature, stabilized thermo-optically functional composite (referred to herein as a “stabilized composite) is disclosed. The stabilized composite includes a phase stabilized matrix including a first component, hereinafter referred to as a “refractory component”, stabilized by a second component, hereinafter referred to as a “stabilizer component” and a plurality of discrete metallic particles interspersed with respect to the matrix, wherein the composite is stable at temperatures greater than about 2000 degrees K.

As used herein, “metallic materials” or “metallic particles” are conductive materials or particles that have overlapping conductance and valence bands in their electronic structure characteristics, whereas “dielectrics” are highly resistant to the flow of electric current.

As used herein, the term “discrete metallic particles” refers to metallic particles, which are physically separated from one another. As used herein, particles may include regularly shaped or irregularly shaped aggregates of smaller particles.

In the context of the stabilized composite described herein, the term “interspersed” is used broadly with respect to particles to mean that the particles are placed, positioned or formed at periodic intervals or random distances within the phase stabilized matrix.

As used herein, the term “periodicity of distribution” is intended to refer to the center-to-center spacing by which two or more interspersed particles may be separated. In the event a specific numerical value for a periodicity of distribution is provided herein, a margin of error of ±10 percent may be assumed.

As used herein the term “stability” (stabilized) (when used independently of a qualifying term such as “phase” or “microstructural”) refers to both phase stability (phase stabilized) and microstructural stability (microstructurally stabilized).

As used herein the term “phase stability” is defined as the stability of a homogenous phase against transformation into a different phase or into multiple phases with changes in environment. Environmental changes which may cause phase change include, but are not limited to, changes in temperature, pressure, mechanical stress, electric fields, magnetic fields and chemical interactions.

As used herein, the term “microstructure” refers to the size, spacing, and periodicity of metallic particles in the matrix. As used herein, the term “microstructural stability” is defined as the stability against microstructural degradation with changes in environment. As discussed above, environmental changes include, but are not limited to, changes in temperature, pressure, mechanical stress, electric fields, magnetic fields and chemical interactions.

Microstructural instability commonly arises from a progressive decrease in either or both the interfacial area between the particles or the total surface area of the particles and thus in free energy. Particle coarsening and grain growth are examples of microstructural instability. Although the Applicants do not wish to be bound by any particular theory, it is believed that the driving force for the coarsening of metallic particles in a matrix is largely governed by the size distribution of the metallic particles. Due to thermodynamic effects, as shown by the Gibbs-Thompson rule, the solubility of the metallic species in a dielectric matrix will be higher near small particles than large ones. The Gibbs-Thompson rule may be represented as

$${C}_{r} = {C}_{∞} exp ( \frac{2 γΩ}{RTr} ) ,$$

where Cᵣ is the mole fraction/volume fraction in a composite, C_{∝} is the mole fraction/volume fraction at equilibrium at a temperature T, γ is the interfacial energy and r is the particle size. This concentration gradient will drive diffusion from small particles to larger ones, as given by Fick's first law of diffusion.

J=−D∇φ, (2)

where J is the diffusion flux in mol/m²*second, D is the diffusion coefficient in m²/seconds) and φ is the concentration in mol/m³.

In one embodiment, a large portion of the free surface area of the particles has been replaced by dielectric-metallic interfaces, which reduces the surface energy associated with them. This reduced energy results in enhanced stability both from increased melting temperatures and decreased driving forces to decrease the surface area to volume ratio. The presence of only discrete metallic particles, as compared to interconnected particles, provides an advantage by reducing the coarsening rate through increased diffusion distances and decreased diffusivity.

The separation of metallic particles results in the diffusion mechanism for coarsening being changed from surface or volume diffusion to diffusion through the matrix. The coarsening rate is limited by the particle spacing, the solubility of the metallic components in the matrix, and the diffusion rate of the metallic component through the matrix. This coarsening rate is expected to be much lower than in an interconnected structure. Furthermore, in order for the metallic particles to coarsen, the matrix must also undergo diffusion to allow for the physical change in the dimensions of the metallic particles. Reducing the polydispersity (non-uniformity of molecular mass) of the metallic particles is expected to thus decrease the driving force for coarsening. A truly monodispersed metallic material is expected to have little driving force for coarsening even at elevated temperatures.

Embodiments of the present invention provide high temperature, stablilized, thermo-optically functional composites (stabilized composites) and systems including such stabilized composites, where the composites include discrete metallic particles. In one embodiment, the stabilized composites described herein may include a phase stabilized matrix including a refractory component stabilized by a stabilizer component and a plurality of discrete metallic particles interspersed with respect to the matrix. The stabilized composite is stable at temperatures greater than about 2000 degrees K. In one embodiment, the phase stabilized matrix forms a dielectric matrix.

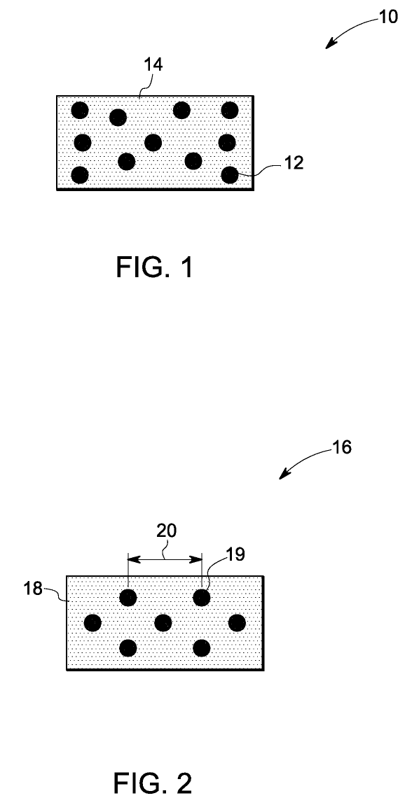

Examples of such stabilized composites are described in FIGS. 1 through 3. FIG. 1 schematically illustrates a stabilized thermo-optically functional composite 10 in accordance with one embodiment. The composite includes discrete metallic particles 12 embedded in a stabilized dielectric matrix 14. In one embodiment, the discrete particles may be randomly distributed inside the stabilized dielectric matrix as shown in FIG. 1.

In an alternate embodiment, as illustrated by the composite 16 in FIG. 2, the discrete metallic particles 19 may be arranged inside the phase stabilized matrix 18 in a periodic distribution. The discrete metallic particles 19 are periodically distributed within the phase stabilized matrix with a spacing 20.

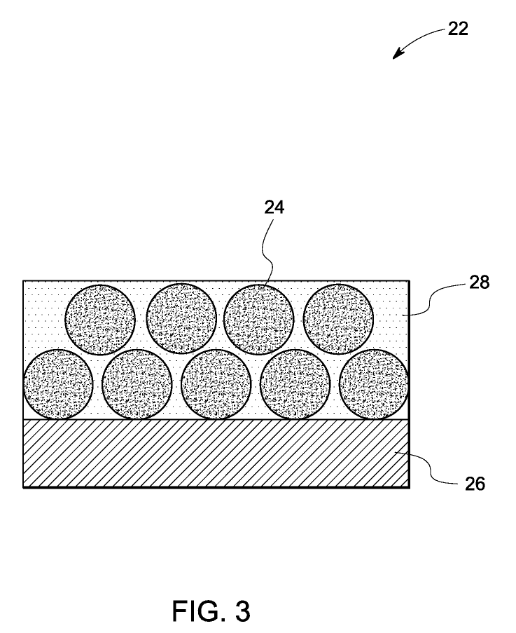

FIG. 3 schematically illustrates a stabilized composite 22 in accordance with one embodiment of the present invention. The stabilized composite 22 includes discrete metallic particles 24 arranged over a substrate 26 with the phase stabilized dielectric material 28 physically separating the discrete particles.

Non-limiting examples of materials that may be used as the refractory component in the phase stabilized matrix include transition metal oxides, rare earth oxides or combinations thereof. Specific examples include but are not limited to hafnia, zirconia or combinations thereof.

In embodiments of the present invention, a stabilizer component capable of stabilizing the refractory component and having sufficient solubility in the refractory component is used along with the refractory component to form a phase stabilized matrix. Non-limiting examples of materials used e.g., as the stabilizer component to stabilize the refractory component in the phase stabilized matrix include but are not limited to magnesium oxide, calcium oxide, yttrium oxide, dysprosia, gadolinium oxide, erbia, neodymia, samarium oxide, ytterbia, zirconia, hafnia, barium oxide, ceria, europia, indium oxide, lanthana, niobia, praseodymia, scandia, strontia, tantala, titania, thulia or combinations thereof.

In one embodiment, the stabilizer component is present in a mole percent from about 3 to about 50 in the matrix. In a further embodiment, the stabilizer component is present in a mole percent from about 5 to about 20 in the matrix.

In one embodiment, the refractory component may include zirconia, hafnia or combinations thereof and the stabilizer component may include magnesium oxide, calcium oxide, yttrium oxide or combinations thereof, and the metallic particles may include tungsten, molybdenum, or combinations thereof.

Examples of stabilized matrices include, but are not limited to, yttria stabilized hafnia matrix, calcia stabilized zirconia matrix, and magnesia stabilized zirconia matrix.

Examples of materials that may be used in metallic particles include W, Re, Os, Ta, Mo, Au, TaN, HfN, ZrN, HfC, TaC, NbC, ZrC, TiC, Ta₂C, Nb₂C, WC, W₂C, SiC and combinations thereof. In one embodiment, the material of the metallic particle is chosen such that the metallic material is inert to the phase stabilized matrix material. The stabilized composite may include metallic particles made of identical materials or different materials.

The metallic particles may take any shape within the stabilized composite. In a non-limiting example, the metallic particles may be spherical or cylindrical in shape. In another example, the metallic particles may be formed in a core shell structure. The metallic particles may also be formed as aggregates of smaller particles.

In one embodiment, desirable optical properties of the stabilized composite, such as light emission, light transmission, light reflection or suppression, may be tailored through the selection of the metallic particle material, metallic particle dimensions, the dielectric matrix material, and the periodicity of distribution of the particles within the matrix.

Embodiments of the presently claimed invention include stabilized composites designed to selectively reflect photons corresponding to at least one range of non-visible radiation wavelengths (such as ultraviolet and infrared) and to selectively emit or transmit photons corresponding to at least one range of visible radiation wavelengths. Because the stabilized composite selectively emits or transmits visible radiation while selectively reflecting the non-visible radiation that would otherwise be radiated as waste heat, it is possible to decrease the amount of input power that would otherwise be needed to achieve the same lumen output. This in turn can result in an increase in the efficiency of systems incorporating the composites claimed herein. Furthermore, due at least in part to the composite structures and material combinations utilized in the formation of the stabilized composite as described herein, the stabilized composite is designed to remain stable at high temperatures, such as above about 2200 degrees K.

In one embodiment, the stabilized composite may be configured to emit predominantly in a wavelength range in the visible region of the electromagnetic spectrum (from about 400 nm and to about 700 nm). In a further embodiment, the stabilized composite is transparent in the visible region of the electromagnetic spectrum. As used herein, transparency may be characterized by an absorption coefficient of less than 10/cm for a specific wavelength or wavelength range. In a non-limiting example, the stabilized composite may be configured such that the emission of the metallic particles in the visible wavelength region is substantially transmitted from the bulk of the composite to outside the composite.

In one embodiment, the stabilized composite is configured to selectively prohibit propagation of infrared wavelengths through the composite. For example, the radiation in the infrared region is suppressed/reflected within the composite.

In a specific embodiment, the stabilized composite includes a transparent dielectric matrix with a plurality of discrete emissive particles interspersed with respect to the matrix. In a non-limiting example, the transparent dielectric matrix includes a stabilized ceramic. The transparent dielectric matrix is stable at least in a temperature range from about 300 degrees K to about 3000 degrees K. Upon thermal excitation the stabilized composite is capable of selective emission in the visible range of the electromagnetic spectrum. In one embodiment, the phase stabilized matrix has a melting point greater than about 2000 degrees K.

As discussed above, desirable optical properties of the stabilized composite may be tailored through the selection of the metallic particle parameters.

In one embodiment, an average particle dimension of the metallic particles may be in a range from about 10 nanometers to about 500 nanometers. In a further embodiment, an average particle dimension may be in a range from about 10 nanometers to about 100 nanometers.

The metallic particles may be arranged randomly within the dielectric matrix or may be spatially ordered within the matrix. In one embodiment, the spatial separation between particles may be greater than about 100 nanometers.

In a spatially ordered configuration, the metallic particles may be spatially ordered with a lattice constant in a range from about 200 nanometers to about 500 nanometers. The particles may be arranged in a simple cubic, a body centered cubic, a face centered cubic, a tetragonal or a hexagonal-close-packed lattice structure.

In one embodiment, the fill factor of the metallic particles may be less than about 10% by volume in the composite. In a further embodiment, the fill factor of the metallic particles may be less than about 5% by volume in the composite. In a still further embodiment, the fill factor of the metallic particles may be in range from about 0.5% to about 2% by volume in the composite.

In certain embodiments, the stabilized discrete metallic particles within the dielectric matrix may be arranged in one or more layers. In one embodiment the metallic particles may be arranged in a single layer. Alternatively, the metallic particles may be arranged in a plurality of layers. In one embodiment, the number of layers may be selected to be in a range from about 2 to about 30 layers. In certain embodiments, the number of layers may be greater than about 30. The discrete metallic particles in any given layer may be include identical materials or different materials. Further, the composition of the discrete metallic particles in different layers may be identical or different.

In a further embodiment, the emissive particles include at least one metallic material with a melting point greater than about 2000 degrees K. Non-limiting examples of metallic materials with melting points greater 2000 degrees Kelvin include tungsten, molybdenum or combinations thereof.

Other embodiments of the present invention include methods for making the high temperature stabilized thermo-optically functional composite. The method includes forming a composition of a refractory component, a stabilizer component and a plurality of metallic particles, wherein the refractory component is capable of stabilizing the stabilizer component. The formation step of this composition can be achieved in a number of ways.

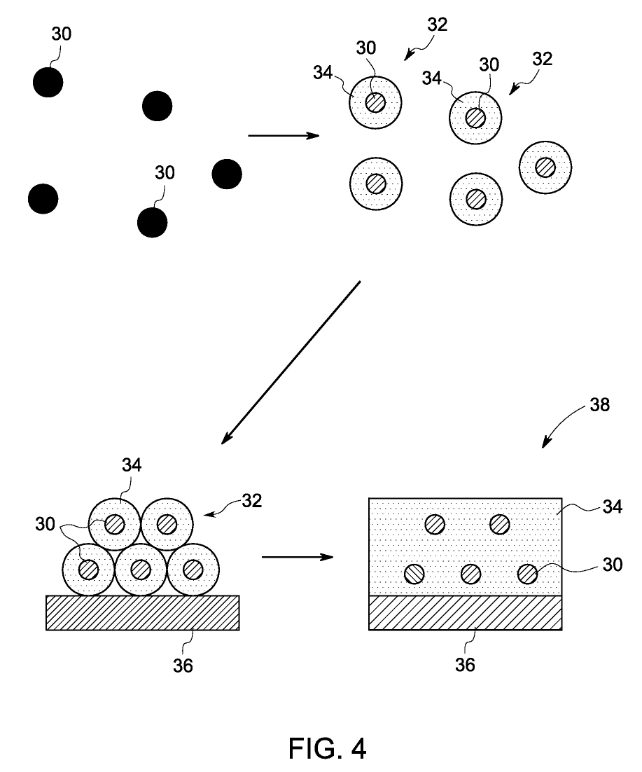

Non-limiting examples of methods for forming the stabilized composite may include coating metallic particles with the refractory and stabilizer components and sintering the coated metallic particles to form a unitary structure. FIG. 4 schematically illustrates one such embodiment of the formation of a stabilized thermo-optically functional composite 38 configured in a ball lattice structure. In the illustrated embodiment, the stabilized composite 38 is formed into a ball lattice by assembling an array of metallic particles 30 or composite particles 32. The composite particle 32 may in turn be formed from a core nanoparticle 30 of a material that is coated or otherwise surrounded by a dielectric material 34. In one embodiment, the core nanoparticles 32 may represent a metal or metal-like material (e.g., as may be determined by the plasma frequency for the material). Since the lattice spacing within the stabilized composite 38 is expected to be a function of the size of the composite particles 34, the size of the core nanoparticles 32 and the dielectric material 34 may be tailored to achieve the desired lattice properties. In one embodiment, the core nanoparticles may have a diameter that ranges in size from about 60 nm to about 350 nm while the dielectric material 22 may range in size such that diameter of the composite particle 32 ranges between about 300 nm and about 500 nm. In one embodiment, the composite particles 32 may be formed into a single monolithic stabilized composite 38 by first assembling the composite particles 32 and in turn sintering the composite particle assembly. In one embodiment, the composite particles 32 may be assembled directly on a substrate, such as the illustrated heating element 36, and then sintered.

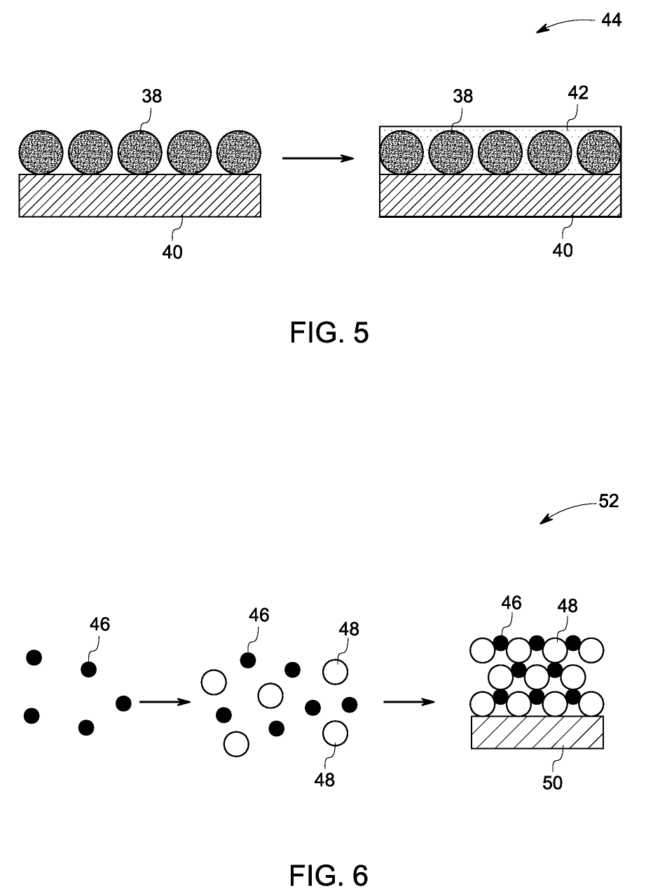

In an alternative example, particles may be ordered over a substrate in a discrete distribution. The voids between the particles may then be filled with the refractory and stabilizer components to form a phase stabilized matrix, where the stabilizer component stabilizes the refractory component. FIG. 5 schematically illustrates one such embodiment. Metallic particles 38 are arranged over a substrate 40. The voids between the metallic particles are filled with a refractory component and stabilizer component 42 to form the stabilized composite 44. In one embodiment, one or more heat treatment steps may be used to form a refractory component stabilized by a stabilizer component. This may be subsequently followed one or more heat treatment steps. Heat treatment steps may be used to increase the density of the composition to form a more compactly packed material.

FIG. 6 schematically illustrates yet another non-limiting example of a method for making a high-temperature stabilized thermo-optically functional material. In the embodiment illustrated in FIG. 6, nanoparticles 46 of a metallic material are combined with nanoparticles 48 of a dielectric material and then assembled onto a substrate or heating element (e.g. heating element 50) to form a lattice structure as shown. For example, suitable assembly techniques for assembling the dielectric particles may include but are not limited to evaporation, electrophoresis, and Langmuir-Blodgett techniques. In one embodiment, the nanoparticles 46 of the metallic material may represent one or more metals or metal-like materials and the nanoparticles 48 of the stabilizer component represent two or more dielectric materials.

Although in certain embodiments the stabilized composite may be coated or otherwise assembled on a substrate or heating element, it is also envisioned that the stabilized composite can be emissive without the need for such an underlying substrate or heating element. In such a case, the stabilized composite could be heated through direct application of current or through the use of inductive heating techniques, for example.

In accordance with another embodiment is a radiation emitter including a high temperature stabilized thermo-optically functional composite incorporated into a luminous element. The luminous element is configured to emit thermal radiation in the visible region of the electromagnetic spectrum. The thermo-optically functional composite includes discrete metallic particles interspersed within a phase stabilized matrix comprising a refractory component stabilized by a stabilizer component, where the stabilized composite is stable at temperatures greater than about 2000 degrees K.

In some embodiments the luminous element may include a substrate. The substrate may be made of materials such as tungsten. The stabilized composite may be disposed or formed as a coating over the substrate. In some embodiments a thickness of the coating may be in a range from about 10 nanometers to 20 microns. In some further embodiments, thickness of the coating may be in a range from about 0.25 micron to 20 microns.

In certain embodiments, the stabilized composite may be embedded into the substrate. Alternatively, the stabilized composite may be thermally coupled to the substrate but not in direct contact with the substrate.

To energize the radiation emitter, electrical leads to supply electrical energy may be incorporated into the radiation emitter connected to the luminous element. In some embodiments, the electrical leads and the luminous element may form a unitary structure.

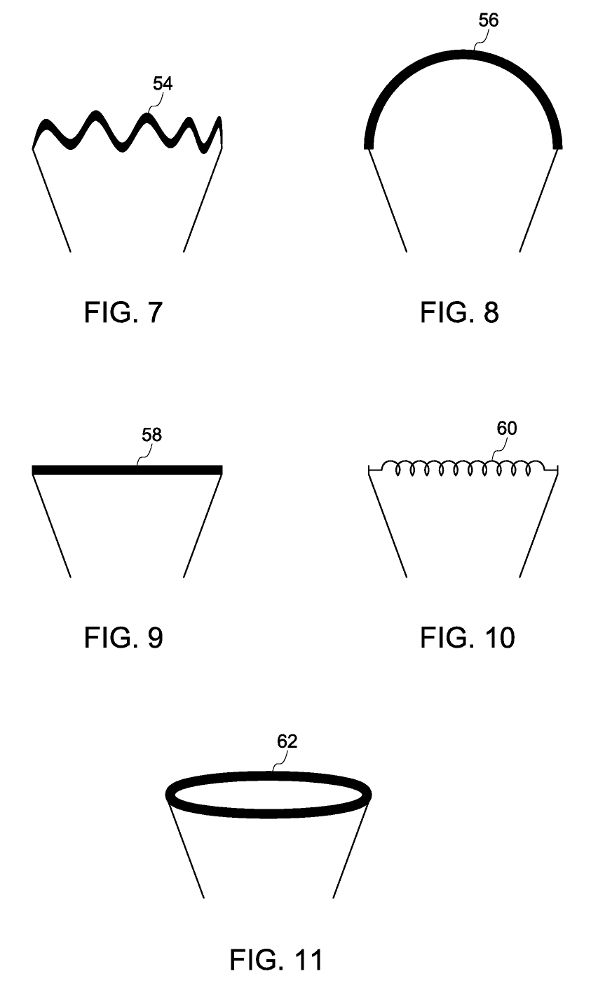

The luminous element in a radiation emitter may be formed in various shapes and structures such as but not limited to a planar structure or a coiled structure. Non-limiting examples of various luminous element structures are illustrated in FIGS. 7 though 11. The luminous element structures depicted in FIGS. 7 through 11 are intended to be illustrative and not limiting. In one example, the luminous element may be a planar ribbon element 54 as shown in FIG. 7. The luminous element of FIG. 8 is a curved element 56. In another example, the luminous element may be a planar structure 58 as shown in FIG. 9. The luminous element illustrated in FIG. 10 represents a coiled element 60 which may be formed in a coiled-coil arrangement. In a further example, the luminous element may be a planar annular element 62 as shown in FIG. 11.

In one embodiment, the emitter may be made optically active through heat treatment. In one example, the emitter may be heated using a tungsten substrate. In another example the emitter may be heated to a point where it conducts electricity at which point it can be resistively heated.

The luminous elements described herein may find further use in various radiation sources. In one embodiment, a radiation source may include a base, a light-transmissive envelope coupled to the base, and a radiation emitter including at least a stabilized thermo-optically functional composite described herein disposed within the light-transmissive envelope.

In one example, the high temperature, stablilized, thermo-optically functional composite may include discrete metallic particles interspersed within a phase stabilized matrix, where the stabilized composite is stable at temperatures greater than about 2000 degrees K and emits visible radiation upon thermal excitation. The stabilized composite may include a matrix formed by a refractory component stabilized by a stabilizer component.

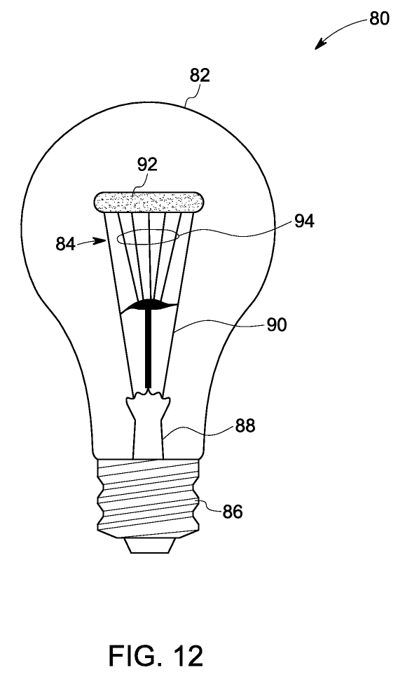

FIG. 12 illustrates a radiation source such as an incandescent lamp including the radiation emitter in accordance with one embodiment of the present invention. As illustrated in FIG. 12, incandescent lamp 80 may include a base 86, a light-transmissive envelope 82, a radiation emitter 84 disposed within the light transmissive envelope 82, and a base 86 to which the light transmissive envelope 82 is coupled. The base 86 is where the electrical contact for the lamp is made and as such, may be fabricated out of any conductive material such as brass or aluminum. The light-transmissive envelope 82 may be fabricated out of glass and may take on any of a wide variety of shapes and finishes.

The radiation emitter 84 may be coupled to the base 86 and may include a stem press 88 lead wires 90, and support wires 94. The radiation emitter 84 may further include a luminous element 92 coupled to the base 86. The lead wires 90 carry the current from the base 86 to the luminous element 92. The lead wires 90 may be made of copper from the base 86 to the stem press 88 and may be made of nickel or nickel-plated copper from the stem press 88 to the luminous element 92. The stem press 88 may be a glass-based structure that holds the radiation emitter 84 in place. The stem press 88 may include an airtight seal around the lead wires 86. In order to balance the coefficients of expansion, the stem press 88 may further include a copper sleeve through which the lead wires 90 are passed. The support wires 94 are used to support the luminous element 92 and may be made from molybdenum, for example.

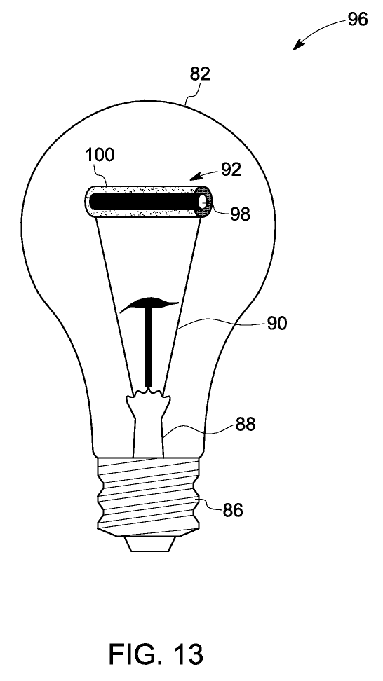

In the embodiment illustrated in FIG. 13, the incandescent lamp 96 is substantially similar to the incandescent lamp 80 of FIG. 12. However, the radiation emitter 84 of the incandescent lamp 96 includes a luminous element 92 that in turn includes an emitter 100 comprising the stablilized thermo-optically functional composite disposed over a core 98. Luminous elements may have various structures as described above. For example, the luminous element may be a coiled element or a planar element. In one non-limiting example, the element may be a double-coiled element including core 98 with the coating 100.

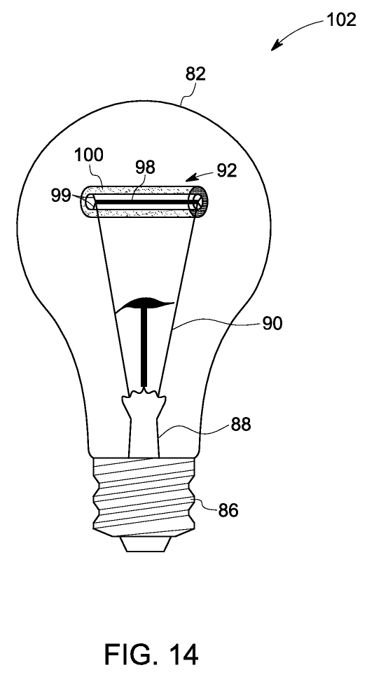

In another non-limiting example, the composite may form an emitter with no direct electrical contact with the core forming a filament. The emitter may be mechanically supported by the core but not electrically connected to it. The emitter may therefore be indirectly heated by the radiation from the core to in turn emit radiation. FIG. 14 illustrates one such embodiment 102, where the emitter 100 is not in direct with the core 98. In the illustrated example, the emitter 100 is supported by insulating supports 99.

In a further embodiment, a gas filling may be disposed within the light transmissive envelope. Non-limiting examples of such gas fillings include noble gases such as but not limited to argon, krypton and gases such as nitrogen. In one example the gas filling may include 95% argon and 5% nitrogen.

In one embodiment, the gas filling may be chosen to be non-reactive to the luminous element material. In an alternative embodiment, the gas filling may be chosen, such that thermodynamic equilibrium is achieved during operation between the gas filling and the material of the luminous element. In another alternative embodiment a gas fill is chosen so as to maintain a constant composition at the emitter surface at the temperature of operation, for example at 2000 degrees K.

The emission quality of radiation sources may be characterized by parameters such as color rendition index (CRI) and color temperature. CRI is a measure of the ability of a light source to reproduce the colors of various objects being lit by the source. In various embodiments including the composites described herein, the color rendition index (CRI) of the radiation source is typically in a range from about 60 to about 100. In some embodiments, the CRI is greater than 75. In some further embodiment, the radiation source has a CRI greater than about 80 during operation. In still further embodiments, the CRI is greater than 90.

Color temperature of a radiation source is determined by comparing the color of the source with a theoretical, heated black-body radiator. In some embodiments of the radiation source including the composites described herein, the color temperature of the radiation source is greater than about 2000 degrees K. In some further embodiments, the color temperature of the radiation sources is greater than 2500 degrees K.

Without further elaboration, it is believed that one skilled in the art can, using the description herein, utilize the present invention to its fullest extent. The following examples are included to provide additional guidance to those skilled in the art in practicing the claimed invention. The examples provided are merely representative of the work that contributes to the teaching of the present application. Accordingly, these examples are not intended to limit the invention, as defined in the appended claims, in any manner.

### EXAMPLE 1

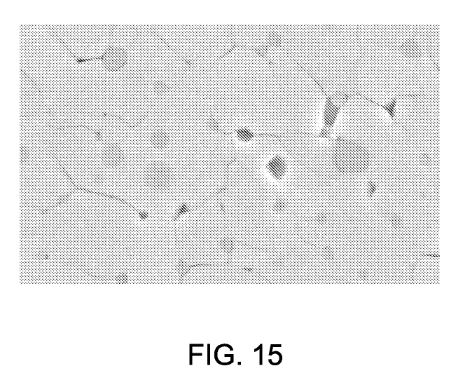

Sample 1 was formed by mixing 4 percent by volume of molybdenum nanoparticles with hafnium oxide powder and hot pressing at 1773 degrees K for 15 minutes to form nearly full density composite. FIG. 15 is an SEM micrograph of Sample 1 after the hot pressing. Much of the molybdenum can be seen to reside at grain boundaries. No significant cracking or chemical interactions can be seen in the as-fabricated samples. The boundaries visible in the as-pressed sample are HfO₂ grain boundaries formed during the pressing operation.

### EXAMPLE 2

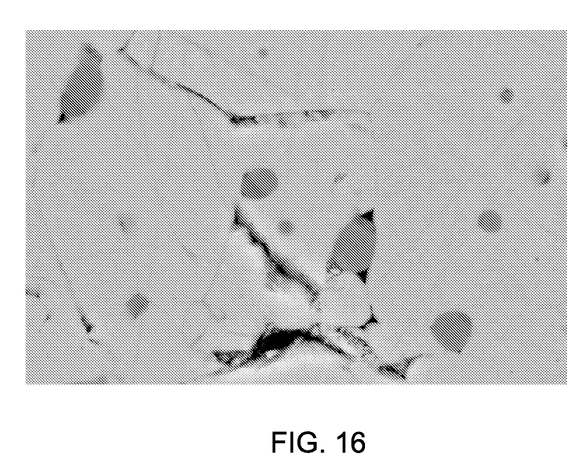

Sample 2 was prepared by mixing 4 percent by volume of molybdenum nanoparticles with hafnium oxide powder and hot pressing at 1673 degrees K followed by heat treatment at 2073 degrees K. FIG. 16 is an SEM micrograph of Sample 2 after the hot pressing and heat treatment. It can be clearly seen that sample 2 exhibits significant cracking after the 2073 degrees K heat treatment.

### EXAMPLE 3

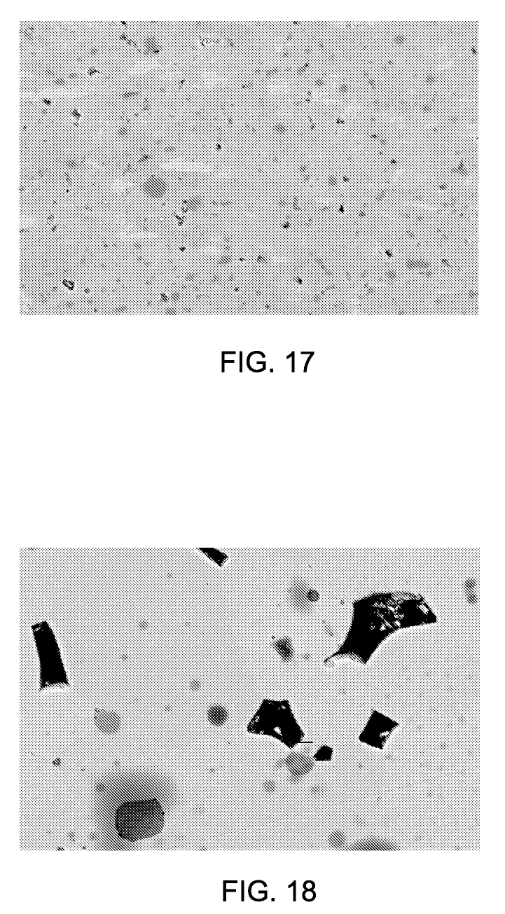

Sample 3 was prepared by mixing 4% by volume of Mo nanopowder into a 15 mole percent yttria stabilized hafnia. In one embodiment of the present invention. FIG. 17 is an SEM micrograph of Sample 3 after the hot pressing at 1673 degrees K. The coarsening behavior of the Mo nanoparticles in yttria stabilized hafnia was also studied. The measured average diameter of the Mo particles as a function of temperature for the sample hot-pressed at 1673 degrees K is shown in Table 1. The error bars represent one standard deviation and are expected to be large as a result of the polydispersity of the starting Mo powder.

TABLE 1
The average measured diameter of molybdenum particles for yttria
stabilized hafnia

| Temperature (K) | Particle Diameter (nm) | Standard Deviation (nm) |
|---|---|---|
| As pressed | 760 | 530 |
| 1673 | 770 | 450 |
| 2073 | 940 | 680 |

### EXAMPLE 4

Sample 4 was prepared by mixing 4% by volume of Mo nanopowder into a 15 mole percent yttria in hafnia in one embodiment of the present invention. FIG. 18 is an SEM micrograph of Sample 4 after the hot pressing and heat treatment at 2073 degrees K. The yttria and hafnia appear to have almost completely reacted to form yttria stabilized hafnia. The small amount of porosity observed appear to be result of a second phase at the grain boundaries that formed during sample preparation. No significant cracking or statistically significant coarsening was observed.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A high temperature, stablilized, thermo-optically functional composite comprising:
a phase stabilized matrix comprising a first component stabilized by a second component; and
a plurality of discrete metallic particles interspersed with respect to the matrix, wherein the composite is stable at temperatures greater than about 2000 degrees K.

2. The composite of claim 1, wherein the phase stabilized matrix forms a dielectric matrix.

3. The composite of claim 1, wherein the first component comprises a material comprising a transition metal oxide, rare earth oxide or combinations thereof.

4. The composite of claim 1, wherein the first component comprises a material comprising zirconia, hafnia, or combinations thereof.

5. The composite of claim 1, wherein the second component comprises a material comprising magnesium oxide, calcium oxide, yttrium oxide, dysprosia, gadolinium oxide, erbia, neodymia, samarium oxide and ytterbia, zirconia, hafnia, barium oxide, ceria, europia, indium oxide, lanthana, niobia, praseodymia, scandia, strontia, tantala, titania, thulia or combinations thereof.

6. The composite of claim 1, wherein the first component comprises a material comprising one transition metal oxide or rare earth oxide or combinations thereof and the second component comprises magnesium oxide, calcium oxide, yttrium oxide or combinations thereof.

7. The composite of claim 1, wherein the first component comprises a material comprising ZrO₂, HfO₂ or combinations thereof and the second component comprises magnesium oxide, calcium oxide, yttrium oxide or combinations thereof.

8. The composite of claim 1, wherein the phase stabilized matrix comprises yttria stabilized hafnia.

9. The composite of claim 1, wherein the metallic particles comprise a material comprising W, Re, Os, Ta, Mo, Au, TaN, HfN, ZrN, HfC, TaC, NbC, ZrC, TiC, Ta₂C, Nb₂C, WC, W₂C, SiC and combinations thereof.

10. The composite of claim 9, wherein the metallic particles comprise a material comprising Mo, W or combinations thereof.

11. The composite of claim 1, wherein the first component comprises a material comprising one transition metal oxide or rare earth oxide or combinations thereof, wherein the second component comprises magnesium oxide, calcium oxide, yttrium oxide, dysprosia, gadolinium oxide, erbia, neodymia, samarium oxide, ytterbia, zirconia, hafnia, barium oxide, ceria, europia, indium oxide, lanthana, niobia, praseodymia, scandia, strontia, tantala, titania, thulia or combinations thereof, and wherein the metallic particles comprise a material comprising W, Re, Os, Ta, Mo, Au, TaN, HfN, ZrN, HfC, TaC, NbC, ZrC, TiC, Ta₂C, Nb₂C, WC, W₂C, SiC and combinations thereof.

12. The composite of claim 1, wherein the first component comprises a material comprising zirconia, hafnia or combinations thereof and the second component comprises magnesium oxide, calcium oxide, yttrium oxide or combinations thereof, wherein the metallic particles comprise a material comprising tungsten, molybdenum, or combinations thereof.

13. The composite of claim 1, wherein the metallic particles comprise a core shell structure.

14. The composite of claim 1, wherein an average particle dimension of the metallic particles is in a range from about 10 nanometers to about 100 nanometers.

15. The composite of claim 1, wherein the particles are spatially separated by a length greater than about 100 nanometers.

16. The composite of claim 1, wherein a fill factor of the metallic particles is less than about 10% by volume in the composite.

17. The composite of claim 16, wherein a fill factor of the metallic particles is less than about 5% by volume in the composite.

18. The composite of claim 17, wherein a fill factor of the metallic particles is in range from about 0.5% to about 2% by volume in the composite.

19. The composite of claim 1, wherein the metallic particles are spatially ordered within the matrix.

20. The composite of claim 1, wherein the metallic particles are spatially ordered with a lattice constant in a range from about 200 nanometers to 500 nanometers.

21. The composite of claim 1, wherein the particles are arranged in a plurality of layers within the matrix.

22. The composite of claim 1, wherein the composite emits in a wavelength range from about 400 nm and to about 700 nm.

23. The composite of claim 1, wherein the composite is transparent in the visible region of the electromagnetic spectrum.

24. The composite of claim 1, wherein the composite is configured to selectively prohibit propagation of infrared wavelengths through the composite.

25. A radiation emitter comprising:
a luminous element configured to emit thermal radiation in the visible region of the electromagnetic spectrum, wherein the luminous element comprises a high temperature, stablilized, thermo-optically functional composite comprising discrete metallic particles interspersed within a phase stabilized matrix comprising a first component stabilized by a second component, wherein the composite is stable at temperatures greater than about 2000 degrees K.

26. The radiation emitter of claim 25, wherein the luminous element further comprises a substrate.

27. The radiation emitter of claim 26, wherein the composite is disposed as a coating over the substrate.

28. The radiation emitter of claim 27, wherein a thickness of the coating is in a range from about 10 nanometers to about 20 microns.

29. The radiation emitter of claim 28, wherein a thickness of the coating is in a range from about 0.25 micron to 20 microns.

30. The radiation emitter of claim 25, wherein the composite is embedded into the substrate.

31. The radiation emitter of claim 25, wherein the composite is mounted on to the substrate but not in direct contact with the substrate.

32. The radiation emitter of claim 25, further comprising electrical leads to supply electrical energy to the luminous element.

33. The radiation emitter of claim 32, wherein the electrical leads and the luminous element form a unitary structure.

34. The radiation emitter of claim 25, wherein the luminous element comprises a coiled element.

35. The radiation emitter of claim 25, wherein the luminous element comprises a planar element.

36. A radiation source comprising:
a base;
a light-transmissive envelope coupled to the base;
high temperature, stablilized, thermo-optically functional composite disposed within the light-transmissive envelope, the high temperature, stablilized, thermo-optically functional composite comprising discrete metallic particles interspersed within a phase stabilized matrix comprising a first component stabilized by a second component, wherein the composite is stable at temperatures greater than about 2000 degrees K and emits visible radiation upon thermal excitation.

37. The radiation source of claim 35, further comprising a gas phase.

38. The radiation source of claim 35, wherein the radiation source during operation has a CRI greater than about 80.

39. The radiation source of claim 35, wherein the radiation source during operation has a color emission greater than about 2500 degrees K.

40. A method of making a high temperature, phase stable, thermo-optically functional composite comprising:
forming a composition of a first component, a second component and a plurality of metallic particles, wherein the first component is capable of stabilizing the second component.

41. The method of claim 40, wherein the forming a composition comprises:
ordering the plurality of particles in one or more layers over a substrate in a predetermined distribution; and
filling voids between the distributed particles with the first and second components.

42. The method of claim 40, wherein the forming a composition comprises:
coating metallic particles with the first and second components; and
sintering the coated metallic particles to form a unitary structure.

43. The method of claim 43, wherein the forming a composition comprises:
forming a core shell nanoparticle, wherein the core comprises one or more metallic particles, and the shell comprises the first component and the second component; and
sintering the coated metallic particles to form a unitary structure.
